(19) United States
(12) Patent Application Publication
(10) Pub. No.: US 2002/0067134 A1
(43) Pub. Date: Jun. 6, 2002

(54) Electroluminescence display which realizes high speed operation and high contrast

(76) Inventor: Shingo Kawashima, Tokyo (JP)

Correspondence Address: McGinn & Gibb, PLLC, Suite 200, 8321 Old Courthouse Road, Vienna, VA, 22182-3817, US

(21) Appl. No.: 09/924,498

(22) Filed: Aug. 9, 2001

(30) Foreign Application Priority Data
Aug. 10, 2000 (JP) 243375/2000

(51) Int. Cl. G09G 3/10

(52) U.S. Cl. 315/169.3

(57) ABSTRACT

An electroluminescence display is composed of an electroluminescence pixel and a driving circuit. The driving circuit drives the electroluminescence pixel to emit light. The driving circuit provides a first drive current, and then provides a second drive current for the electroluminescence pixel. The first drive current is larger than the second drive current, and increases depending on the second drive current.

### BACKGROUND OF THE INVENTION

1. Field of the Invention

The present invention relates to an electroluminescence display (hereafter, referred to as an EL display). More particularly, the present invention relates to an electroluminescence display including a drive circuit that drives EL pixels at a high speed.

2. Description of the Related Art

An EL display has been widely used. FIG. 1 shows the configuration of a matrix type organic EL display. A driving circuit 101 is connected to organic EL pixels 102. The organic EL pixel 102 is connected to a horizontal drive switch 103. The horizontal drive switch 103 is connected to a ground terminal 104 and a power supply 105.

The driving circuit 101 drives one of the organic EL pixels 102 connected thereto. Which one of the organic EL pixels 102 is driven is determined by the horizontal drive switch 103. The organic EL pixel 102 is connected to any one of the ground terminal 104 and the power supply 105 by the horizontal drive switch 103, and a drive current flows through the organic EL pixel 102 connected to the ground terminal 104. That is, the organic EL pixel 102 connected to the ground terminal 104 is driven by the driving circuit 101.

On the other hand, the drive current does not flow through the organic EL pixel 102 connected to the power supply 105.

FIG. 2 shows the structure of each organic EL pixel 102. An anode 109, an organic film 110 and a cathode 111 are formed in turn on a transparent substrate 108. Electro-luminescence phenomenon causes the organic film 110 to emit a light.

FIG. 3 shows the equivalent circuit of the organic EL pixel 102. The organic EL pixel 102 is represented by the circuit in which a parasitic capacitor 112 and a light emitting diode 113 are connected parallel to each other. The parasitic capacitor 112 indicates a capacitance formed between the anode 109 and the cathode 111. A thickness of the organic film 110 is thin, typically ranging from 100 nm to 200 nm. The parasitic capacitor 112 typically has a capacitance of about 3 to 4 pF when a pixel size is 0.03 square millimeters.

FIG. 4 shows the dependency between a light emission intensity of the organic EL pixel 102 and a voltage applied to the organic EL pixel 102. The organic EL pixel 102 emits light when the voltage applied thereto exceeds a light emission start voltage V_{T}. The light emission start voltage V_{T} depends on color of the light, ranging from 5 to 10 V. It is necessary to charge the parasitic capacitor 112 of the organic EL pixel 102 to the light emission start voltage V_{T} in order that the organic EL pixel 102 emits the light. A rapid charge of the parasitic capacitor 112 shortens the time necessary for the light emission of the organic EL pixel 102.

A light emitting display is disclosed in Japanese Laid Open Patent Application (JP-A-Heisei, 11-231834), in which a parasitic capacitor of an EL pixel is charged at a high speed. In the conventional light emitting display, the time necessary for the light emission of the EL element is shortened by the following operation. When a drive is started, a constant charge voltage is firstly applied to the EL pixel to charge the parasitic capacitor. The charge voltage is selected such that the parasitic capacitor is charged at the high speed. In succession, a drive current to enable the light emission of a desirable intensity flows through the EL pixel. The time necessary for the light emission of the EL element is shortened by charging the parasitic capacitor at the high speed.

However, it is difficult that the conventional light emitting display has a high contrast. In order that the EL pixel emits a light at a high intensity, it is necessary to increase a charge voltage applied when the drive is started. However, the increase in the charge voltage disables the EL pixel to emit the light at a low intensity, because at least the charge voltage is applied to the EL pixel. On the other hand, if the charge voltage is decreased such that the EL pixel can emit the light at the low intensity, the EL pixel can not emit the light at the high intensity.

It is desirable that the EL display has a high contrast.

Also, the conventional light emitting display is susceptible to the influence from an ambient temperature. As shown in FIG. 5, an intensity-drive voltage property of an EL pixel is largely varied depending on the ambient temperature. The light emission intensity of the EL pixel largely depends on the ambient temperature, because the constant charge voltage is applied to the EL pixel light emitting display when the drive is started.

Moreover, the variation in the ambient temperature causes the tonality to be changed. This is because the variation degree of the intensity-drive voltage property of the EL pixel with respect to the ambient temperature is different depending on the light emission color of the EL pixel.

It is desirable that the EL display is not susceptible to the influence from the ambient temperature. In particular, it is desirable that the light emission intensity and the tonality are not susceptible to the influence from the ambient temperature.

Other techniques for driving EL pixels are disclosed in Japanese Open Laid Patent Application (JP-A-Heisei 11-45071, and Jp-A-Heisei 11-282419). However, these techniques do not solve the above-mentioned problems.

### SUMMARY OF THE INVENTION

Therefore, an object of the present invention is to increase a contrast of an EL display.

Another object of the present invention is to provide an EL display in which a time necessary for a light emission is shorten and a contrast is high.

Still another object of the present invention is to provide an EL display that is not susceptible to an influence from an ambient temperature.

Still another object of the present invention is to provide an EL display in which a time necessary for a light emission is shortened and it is not susceptible to an influence from an ambient temperature.

In order to achieve an aspect of the present invention, an electroluminescence display is composed of an electroluminescence pixel and a driving circuit. The driving circuit drives the electroluminescence pixel to emit light. The driving circuit provides a first drive current, and then provides a second drive current for the electroluminescence pixel. The first drive current is larger than the second drive current, and increases depending on the second drive current.

The second drive current is preferably determined based on a brightness of the light.

Also, the first drive current is preferably smaller than a limit current for maintaining a current-brightness property of the electroluminescence pixel substantially linear.

Preferably, the first drive current is k times as large as the second drive current, where k is a constant larger than 1.

The k is preferably defined such that

k≦Iₘₐₓ/Iₒᵤₜ₂₋ₘₐₓ,

where Iₘₐₓ is a limit current for maintaining a current-brightness property of the electroluminescence pixel substantially linear, and Iₒᵤₜ₂₋ₘₐₓ is a maximum value of the second drive current.

The k is preferably determined based on a color of light emitted by the electroluminescence pixel.

The driving circuit preferably includes a first current source unit generating a first current, a second current source unit generating a second current, and a current output unit superposing the first and second current to generate the first drive current.

The current output unit preferably generates the second drive current from the first current.

In order to achieve another aspect of the present invention, a method of operating a electroluminescence display is composed of:

providing a first drive current with a electroluminescence pixel; and

providing a second drive current with the electroluminescence pixel after the providing the first drive current. The first drive current is larger than the second drive current, and increases depending on the second drive current.

### BRIEF DESCRIPTION OF THE DRAWINGS

FIG. 1 shows a configuration of a conventional EL display;

FIG. 2 shows a configuration of an organic EL pixel 102;

FIG. 3 shows an equivalent circuit of the organic EL pixel 102;

FIG. 4 shows a dependency between a light emission intensity of the organic EL pixel 102 and a voltage applied to the organic EL pixel 102; and

FIG. 5 shows an intensity-drive voltage property of an EL pixel.

FIG. 6 shows a configuration of an EL display of an embodiment according to the present invention;

FIG. 7 shows a waveform of a drive current Iₒᵤₜ that a driving circuit 1 outputs to an organic EL pixel 2;

FIG. 8A shows a waveform of a drive current Iₒᵤₜ;

FIG. 8B shows a waveform of a terminal voltage V_{c} of the organic EL pixel 2;

FIG. 8C shows a waveform of a current Iₗᵤₘ contributing to a light emission among the currents flowing through the organic EL pixel 2;

FIG. 9 shows an equivalent circuit of the organic EL pixel 2;

FIG. 10 shows a configuration of the driving circuit 1;

FIG. 11 shows a current-intensity property of the organic EL pixel 2;

FIG. 12 shows a configuration of a driving circuit 21 of an EL display in a second embodiment;

FIG. 13A is a timing chart showing an operation of the driving circuit 21; and

FIG. 13B shows a waveform of a drive current Iₒᵤₜ′.

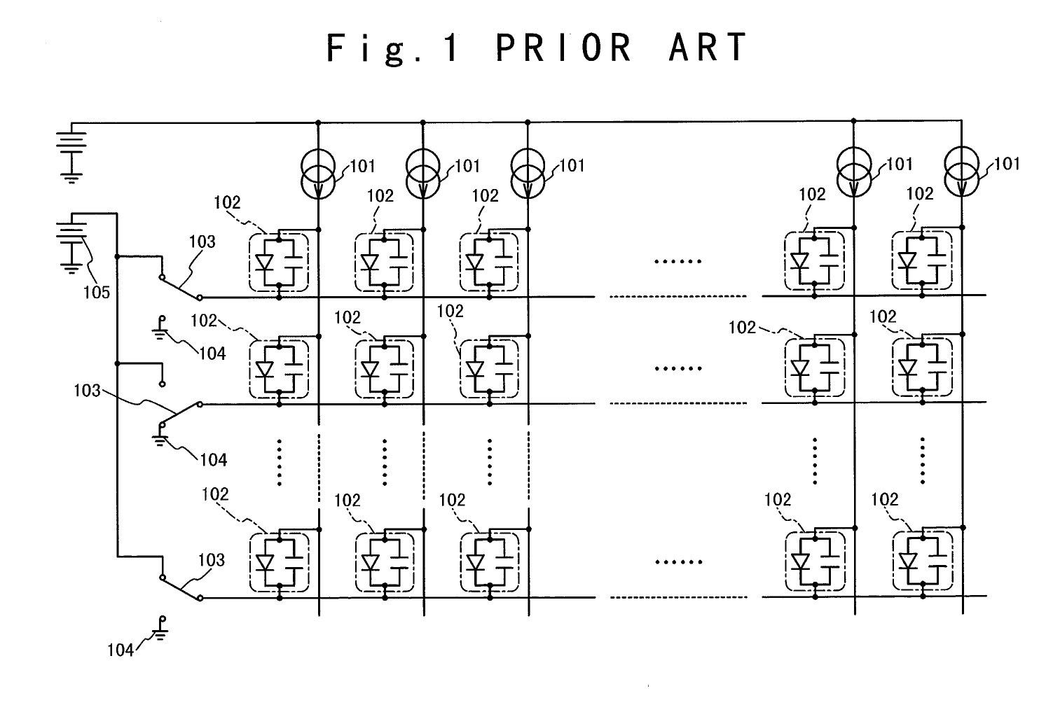

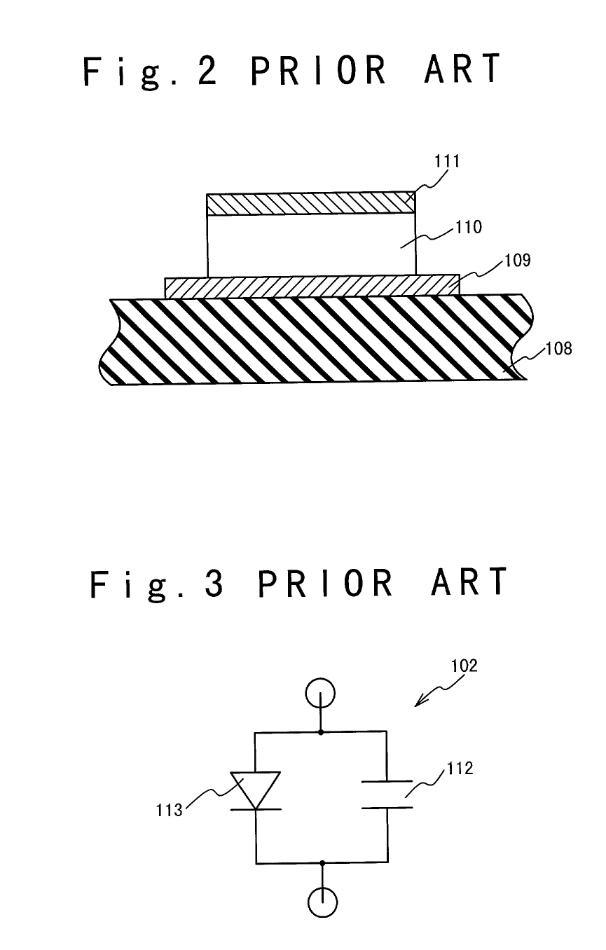

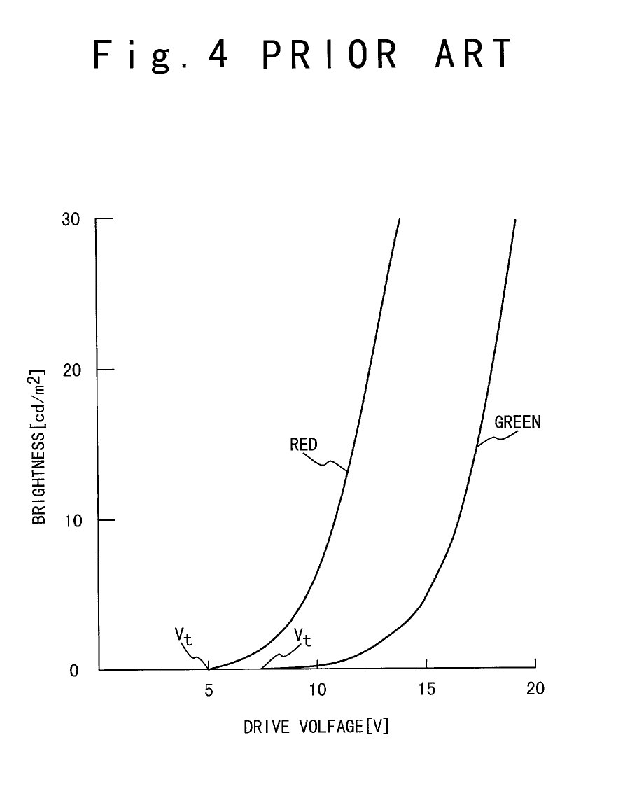

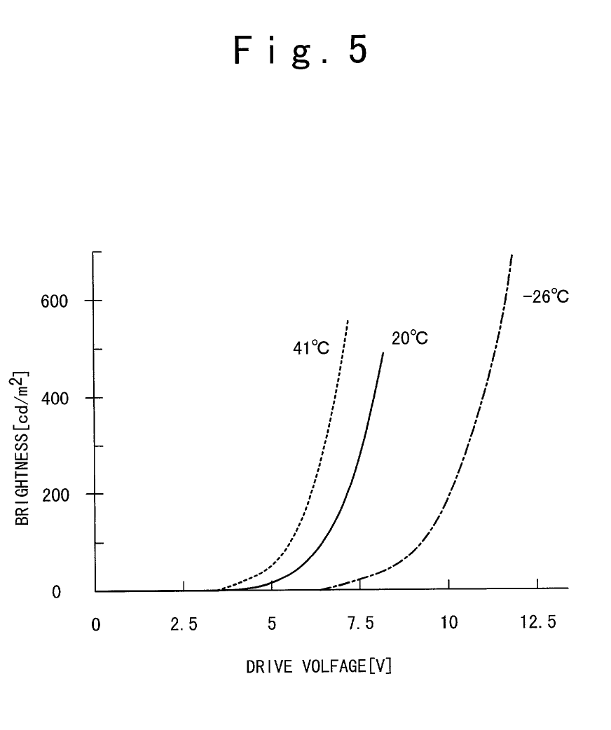

### DESCRIPTION OF THE PREFERRED EMBODIMENTS

An EL display of an embodiment according to the present invention will be described below with reference to the attached drawings.

### First Embodiment

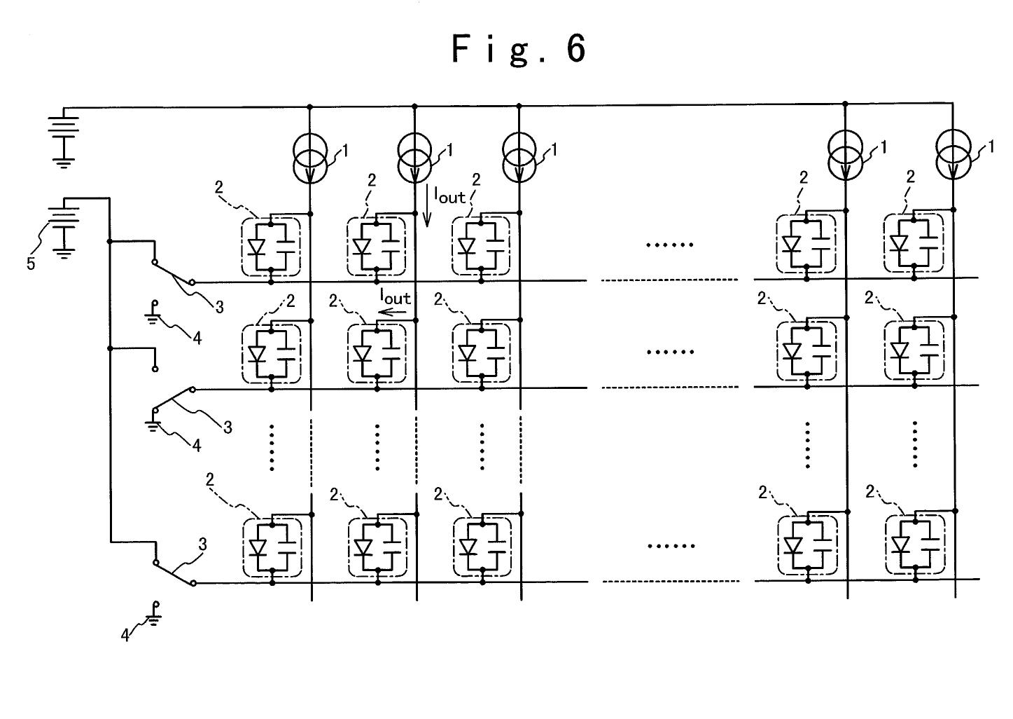

FIG. 6 shows the configuration of an organic EL display of a first embodiment. The organic EL display is provided with driving circuits 1, organic EL pixels 2, horizontal drive switches 3, a ground terminal 4 and a power supply 5.

The driving circuit 1 is connected to the organic EL pixels 2. The organic EL pixel 2 is connected to the horizontal drive switch 3. The horizontal drive switch 3 is connected to the ground terminal 4 and the power supply 5.

The driving circuit 1 drives one of the organic EL pixels 2 connected thereto. Which one of the organic EL pixels 2 is driven is determined by the horizontal drive switch 3. The organic EL pixel 2 is connected to any one of the ground terminal 4 and the power supply 5 by using the horizontal drive switch 3, and a drive current flows through the organic EL pixel 2 connected to the ground terminal 4. That is, the organic EL pixel 2 connected to the ground terminal 4 is driven by the driving circuit 1. On the other hand, the drive current does not flow through the organic EL pixel 2 connected to the power supply 5.

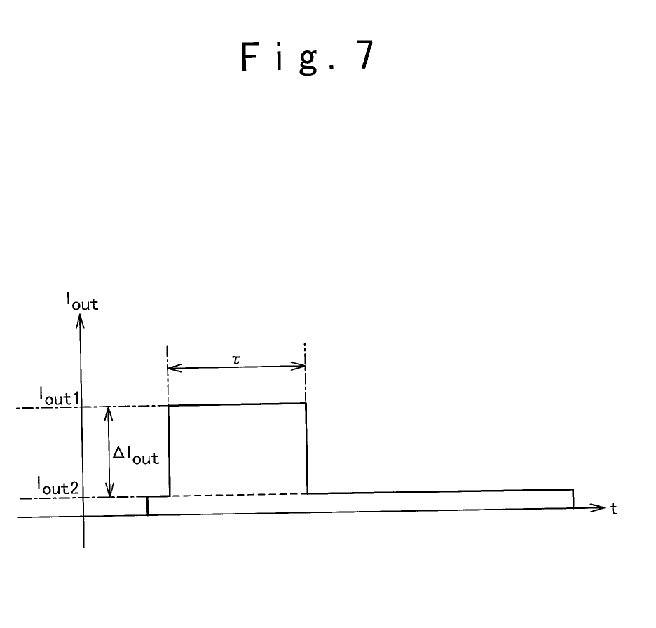

FIG. 7 shows a waveform of the drive current Iₒᵤₜ, which the driving circuit 1 outputs to the organic EL pixel 2, when the organic EL pixel 2 is driven. When the drive of the organic EL pixel 2 is started, the charge drive current Iₒᵤₜ₁ flows through the organic EL pixel 2 only for a time τ. The parasitic capacitor of the organic EL pixel 2 is charged by the charge drive current Iₒᵤₜ₁.

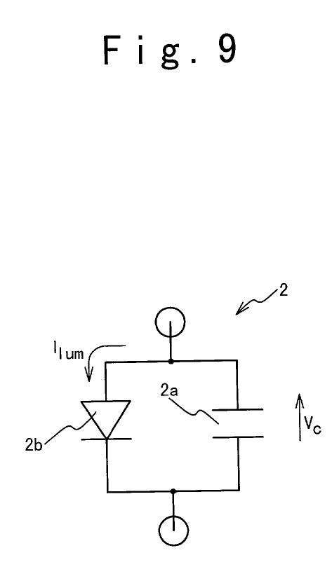

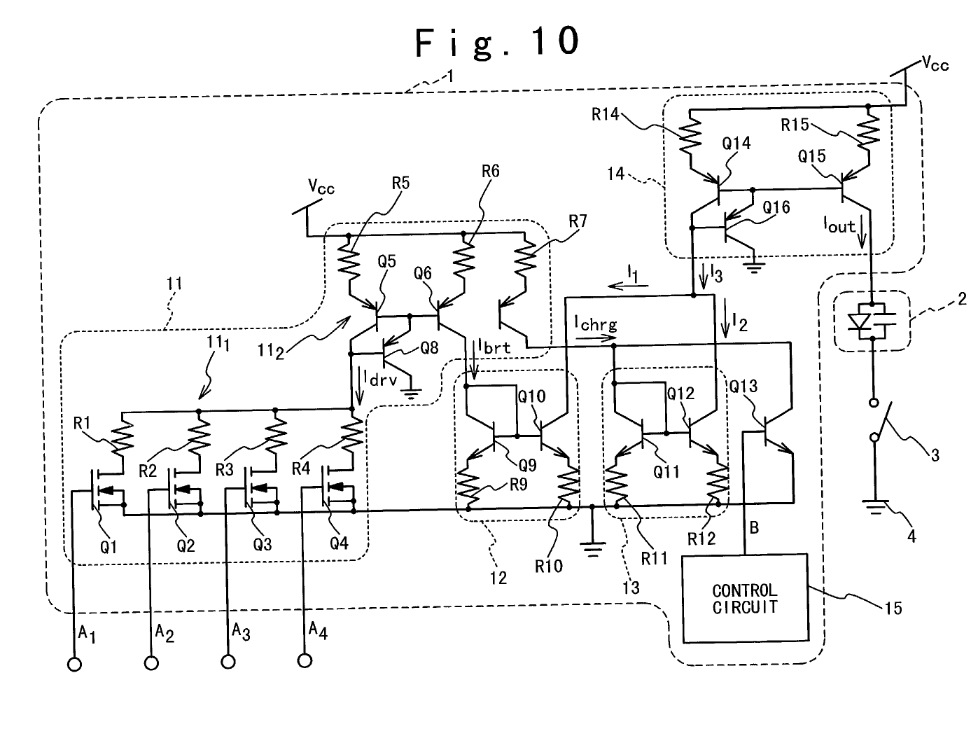

In succession, a light emission drive current Iₒᵤₜ₂ flows through the organic EL pixel 2. The light emission drive current Iₒᵤₜ₂ is determined such that the organic EL pixel 2 emits a light at a desirable intensity, on the basis of the current-intensity property of organic EL pixel 2. At this time, the charge drive current Iₒᵤₜ₁ is greater by ΔIₒᵤₜ than the light emission drive current Iₒᵤₜ₂. FIGS. 3A, 3B and 3C show a waveform of a drive current Iₒᵤₜ, a waveform of a terminal voltage V_{c} of the organic EL pixel 2 when the drive current Iₒᵤₜ is outputted to the organic EL pixel 2, and a waveform of a current Iₗᵤₘ contributing to the light emission among the currents flowing through the organic EL pixel 2, respectively. Here, let us suppose that the organic EL pixel 2 is represented by the equivalent circuit shown in FIG. 9. The terminal voltage V_{c} corresponds to a voltage applied to a parasitic capacitor 2a. Moreover, the current Iₗᵤₘ corresponds to a current flowing through a light emitting diode 2b.

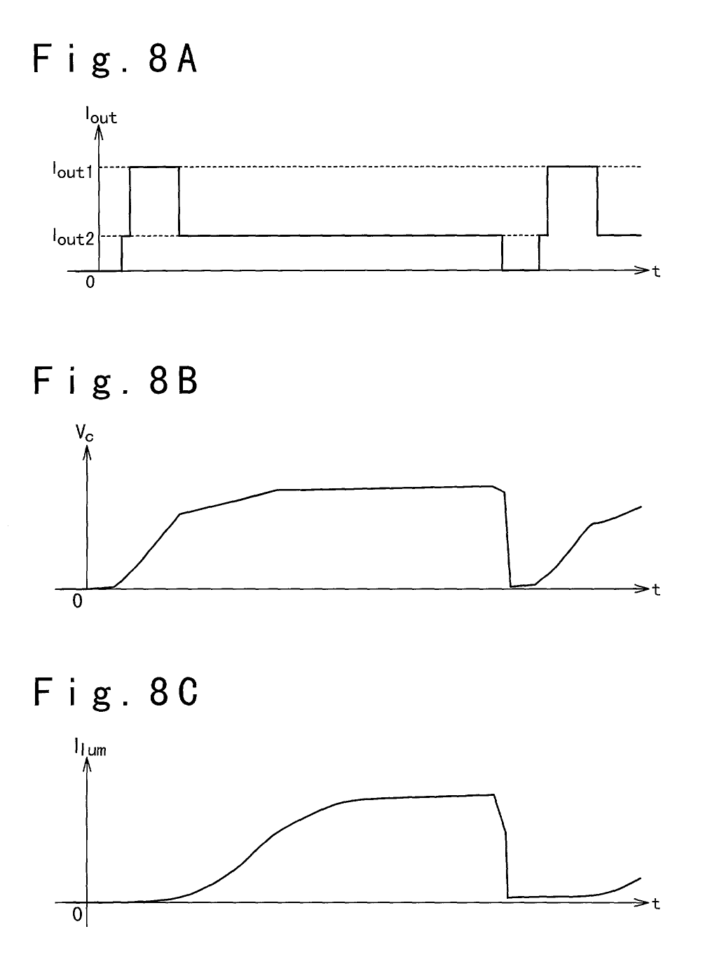

As shown in FIG. 8A, when the drive of the organic EL pixel 2 is started, the charge drive current Iₒᵤₜ₁ flows as the drive current Iₒᵤₜ. Accordingly, the parasitic capacitor 2a is quickly charged to thereby increase the terminal voltage V_{c} at a high speed. After the terminal voltage V_{c} is risen up, the current Iₗᵤₘ is increased as shown in FIG. 8C. The current Iₗᵤₘ is substantially equal to the light emission drive current Iₒᵤₜ₂ after being saturated.

The charge drive current Iₒᵤₜ₁ increased depending on the light emission drive current Iₒᵤₜ₂. It is designed such that the greater the light emission drive current Iₒᵤₜ₂, the greater the charge drive current Iₒᵤₜ₁. This implies the design in which as the organic EL pixel 2 emits the light at a higher intensity, the charge drive current Iₒᵤₜ₁ becomes greater. The thus-determined design of the charge drive current Iₒᵤₜ₁ contributes to the higher contrast of the organic EL display. Moreover, this design contributes to the little influence of an ambient temperature on the organic EL display.

FIG. 10 shows the driving circuit 1 for outputting the drive current Iₒᵤₜ. The driving circuit 1 includes a signal current generator 11, current mirrors 12, 13 and 14, a controller 15 and a transistor Q13. The driving circuit 1 outputs the drive current Iₒᵤₜ to the organic EL pixel 2 and drives the organic EL pixel 2.

The signal current generator 11 contains a digital-analog converter 11₁ and a current mirror 112. The digital-analog converter 11₁ includes transistors Q1 to Q4 and resistors R1 to R4. The current mirror 11₂ includes transistors Q5 to Q8 and resistors R5 to R7.

The digital-analog converter 11₁ draws out a drive current indication current I_{drv} from the current mirror 11₂. The intensity of the drive current indication current I_{drv} is determined on the basis of current setting digital signals A₁ to A₄. The drive current indication current I_{drv} is determined so as to be proportional to the light emission drive current Iₒᵤₜ₂. The current mirror 11₂ outputs a light emission current indication current I_{brt} and a charge current indication current I_{chrg}, based on the drive current indication current I_{drv}. The light emission current indication current I_{brt} is equal to a₁ times the drive current indication current I_{drv}. The charge current indication current I_{chrg} is equal to a₂ times the drive current indication current I_{drv}. The light emission current indication current I_{brt} determines the light emission drive current Iₒᵤₜ₂ in the drive current Iₒᵤₜ. The charge current indication current I_{chrg} determines a difference Δ Iₒᵤₜ between the charge drive current Iₒᵤₜ₁ and the light emission drive current Iₒᵤₜ₂.

The light emission current indication current I_{brt} flows into the current mirror 12. The current mirror 12 is composed of transistors Q9, Q10 and resistors R9, R10. The current mirror 12 draws out a current I₁ equal to b₁ times the light emission current indication current I_{brt} from the current mirror 14.

On the contrary, the charge current indication current I_{chrg} flows into the current mirror 13 or the transistor Q13, on the basis of a charge control signal B outputted by the control circuit 15. If the transistor Q13 is turned on in response to the charge control signal B, the charge current indication current I_{chrg} flows into the transistor Q13, and does not flow into the current mirror 13. On the other hand, if the transistor Q13 is turned off in response to the charge control signal B, the charge current indication current I_{chrg} flows into the current mirror 13.

The current mirror 13 is composed of transistors Q11, Q12 and resistors R11, R12. The current mirror 13 draws out a current equal to b₂ times the current flowing thereto, from the current mirror 14. The current mirror 13 causes a current I₂ drawn out from the current mirror 14 to be equal to b₂ times the charge current indication current I_{chrg}, or the current mirror 13 draws out no current from the current mirror 14, which leads to the I₂=0.

The currents I₁, I₂ are superposed on each other and become a current I₃. The current mirrors 12, 13 cause the current I₃ to be drawn out from the current mirror 14.

The current mirror 14 is composed of transistors Q14 to Q16 and resistors R14, R15. The current mirror 14 outputs a current equal to c times the current I₃ as the drive current Iₒᵤₜ to the organic EL pixel 2. That is, the drive current Iₒᵤₜ becomes the current in which the current equal to c times the current I₁ and the current equal to c times the current I₂ are superposed on each other.

The operations of the respective sections of the driving circuit 1 when the organic EL pixel 2 is driven is described below.

When the drive of the organic EL pixel 2 is started, the transistor Q13 is turned off by the charge control signal b. In addition, the light emission drive current Iₒᵤₜ₂ is specified by the current setting digital signals a1 to a4. The light emission drive current Iₒᵤₜ₂ is determined on the basis of an intensity of a light emitted by the organic EL pixel 2. In response to the current setting digital signals A₁ to A₄, the drive current indication current I_{drv} corresponding to the light emission drive current Iₒᵤₜ₂ is drawn out from the current mirrors 11₂ by the digital-analog converter 11₁. The light emission current indication current I_{brt} and the charge current indication current I_{chrg} are outputted from the current mirrors 11₂. That is, they are represented by:

I_{brt}=a₁·I_{drv},

I_{chrg}=a₂·I_{drv}.

The light emission current indication current I_{brt} is outputted to the current mirror 12. The current mirror 12 draws out the current I₁ equal to b₁ times the light emission current indication current I_{brt} from the current mirror 14. Moreover, since the transistor Q13 is turned off, the charge current indication current I_{chrg} is outputted to the current mirror 13. Then, the current I₂ equal to b₂ times the light emission current indication current I_{brt} is drawn out from the current mirror 14. That is, they are represented by:

I₁=a₁·b₁·I_{drv},

I₁=a₂·b₂·I_{drv}.

Here, the I₃ is represented by:

$$\begin{matrix}{I}_{3} = {I}_{1} + {I}_{2} \\ = ( {a}_{1} \cdot {b}_{1} + {a}_{2} \cdot {b}_{2} ) {I}_{drv} .\end{matrix}$$

Thus, the charge drive current Iₒᵤₜ₁ outputted to the organic EL pixel 2 immediately after the start of the drive of the organic EL pixel 2 is represented by:

$$\begin{matrix}{I}_{out1} = c \cdot {I}_{3} \\ = ( {a}_{1} \cdot {b}_{1} + {a}_{2} \cdot {b}_{2} ) \cdot c \cdot {I}_{drv} .\end{matrix}$$

The charge drive current Iₒᵤₜ₁ is outputted to the organic EL pixel 2 only for the predetermined time τ. It is desirable that the charge drive current Iₒᵤₜ₁ continues to flow until a voltage between the terminals of the organic EL pixel 2 exceeds the light emission start voltage V_{T}.

After that, the transistor Q13 is turned on by the charge control signal B. The charge current indication current I_{chrg} flows into the transistor Q13, and it does not flow into the current mirror 13. Thus, I₂=0.

The light emission drive current Iₒᵤₜ₂ is represented by:

$$\begin{matrix}{I}_{out2} = c \cdot {I}_{3} \\ = {a}_{1} \cdot {b}_{1} \cdot c \cdot {I}_{drv} .\end{matrix}$$

The light emission drive current Iₒᵤₜ₂ is selected such that the organic EL pixel 2 emits the light having a desirable intensity when the light emission drive current Iₒᵤₜ₂ flows through the organic EL pixel 2. The drive current indication current I_{drv} is determined correspondingly to the light emission drive current Iₒᵤₜ₂.

At this time, the charge drive current Iₒᵤₜ₁ is represented by:

Iₒᵤₜ₁=k·Iₒᵤₜ₂,

k=(a₁·b₁+a₂·b₂)/(a₁·b₁).

In this way, the charge drive current Iₒᵤₜ₁ is determined such that the charge drive current Iₒᵤₜ₁ increases depending on the light emission drive current Iₒᵤₜ₂. That is, it is designed such that as the organic EL pixel 2 emits the light at the higher intensity, the charge drive current Iₒᵤₜ₁ becomes greater.

The above-mentioned operation of the driving circuit 1 improves the contrast of the EL display. The charge drive current Iₒᵤₜ₁ is determined on the basis of the intensity of the light emitted by the organic EL pixel 2. If the organic EL pixel 2 emits the light at the higher intensity, the charge drive current Iₒᵤₜ₁ is also greater so that the organic EL pixel 2 is charged to a high terminal voltage. On the other hand, if the organic EL pixel 2 emits the light at the low intensity, the charge drive current Iₒᵤₜ₁ is also smaller so that the organic EL pixel 2 is charged to a low terminal voltage. Thus, it is possible to widen the range of the intensity at which the EL display can emit the light. That is, it is possible to increase the contrast of the EL display.

Moreover, the influence of the ambient temperature on the EL display is suppressed. This is because the organic EL pixel 2 is driven by the current. As mentioned above, the brightness-drive voltage property of the EL pixel is largely varied with regard to the ambient temperature. However, the drive current-brightness property of the EL pixel is not easily varied with regard to the ambient temperature. Thus, the influence of the ambient temperature on the EL display can be reduced by the mechanism that the organic EL pixel 2 is perfectly driven by the current.

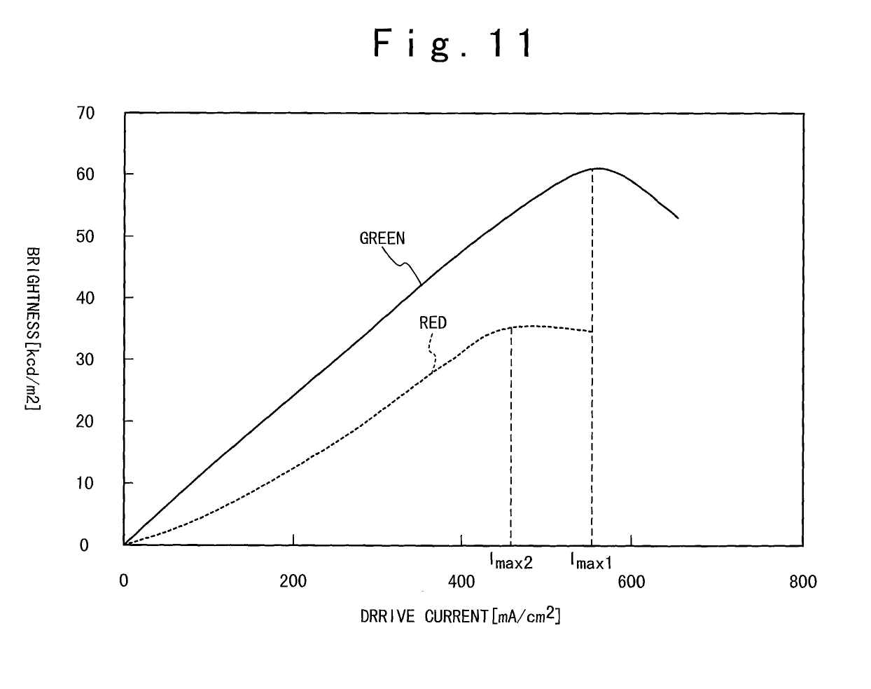

Here, it is desirable that the charge drive current Iₒᵤₜ₁ is determined within the following range. FIG. 11 shows the current-brightness property of the organic EL pixel 2. Let us consider the case of the light emission of green. The intensity of the organic EL pixel 2 is substantially linearly changed with respect to the current flowing into it, within the range smaller than the limit current Iₘₐₓ₁. If the current flowing into the organic EL pixel 2 exceeds the limit current Iₘₐₓ₁, the intensity of the organic EL pixel 2 is decreased. If the current exceeding the limit current Iₘₐₓ₁ flows into the organic EL pixel 2, the organic EL pixel 2 is suddenly deteriorated. The charge drive current Iₒᵤₜ₁ is desired to be smaller than the limit current Iₘₐₓ₁ implying the maximum current under which the current-intensity property of the organic EL pixel 2 can hold its substantial linearity.

At this time, the above-mentioned k (=Iₒᵤₜ₁/Iₒᵤₜ₂) is desired to be determined so as to satisfy the following equation:

k≦Iₘₐₓ₁/Iₒᵤₜ₂₋ₘₐₓ

Here, the Iₒᵤₜ₂₋ₘₐₓ is the maximum value of the light emission drive current Iₒᵤₜ₂, namely, the light emission drive current Iₒᵤₜ₂ when the organic EL pixel 2 emits the light while the intensity is kept at a maximum. Such determination of the k prevents the organic EL pixel 2 from being uselessly deteriorated.

As for the organic EL pixel 2 emitting red light, the k is also determined in the above-mentioned manner. In this case, the charge drive current Iₒᵤₜ₁ is desired to be smaller than the maximum limit current Iₘₐₓ₂ implying the maximum current under which the current-brightness property of the organic EL pixel 2 holds its substantial linearity. Moreover, it is desirable that A≦Iₘₐₓ₁/Iₒᵤₜ₂₋ₘₐₓ.

The limit current implying the maximum current under which the current-intensity property of the organic EL pixel 2 holds its substantial linearity is different depending on the color of the light emission. Thus, the k is desired to be determined on the basis of the color of the light emission.

### Second Embodiment

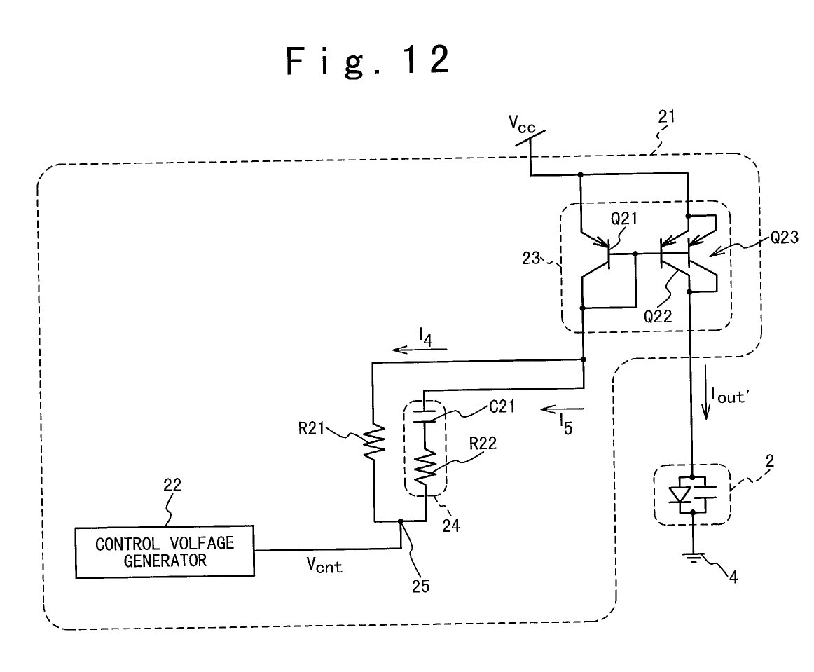

The second embodiment uses a driving circuit 21 having a configuration shown in FIG. 12, instead of the driving circuit 1 in the first embodiment. The driving circuit 21 is provided with a control voltage generator 22, a current mirror 23, a differentiating circuit 24 and a resistor R21. The control voltage generator 22 outputs a control voltage V_{cnt} to a node 25. The node 25 is connected to one terminal of the resistor R21. The other terminal of the resistor R21 is connected to the current mirror 23. A current I₄ flows from the current mirror 23 to the resistor R21.

The node 25 is further connected to the differentiating circuit 24. The differentiating circuit 24 contains a resistor R22 and a condenser C21 which are connected in series. The resistor R21 and the differentiating circuit 24 are connected parallel to each other. The differentiating circuit 24 is connected to the current mirror 23. The current I₅ flows from the current mirror 23 to the differentiating circuit 24.

The current I₆, in which the current I₄ and the current I₅ are superimposed on each other, flows from the current mirror 23 to the control voltage generator 22. The current mirror 23 has transistors Q21 to Q23. The current mirror 23 outputs a current equal to d times the current I₆ as the drive current Iₒᵤₜ. to the control voltage generator 22.

The operation of the driving circuit 21 will be described below.

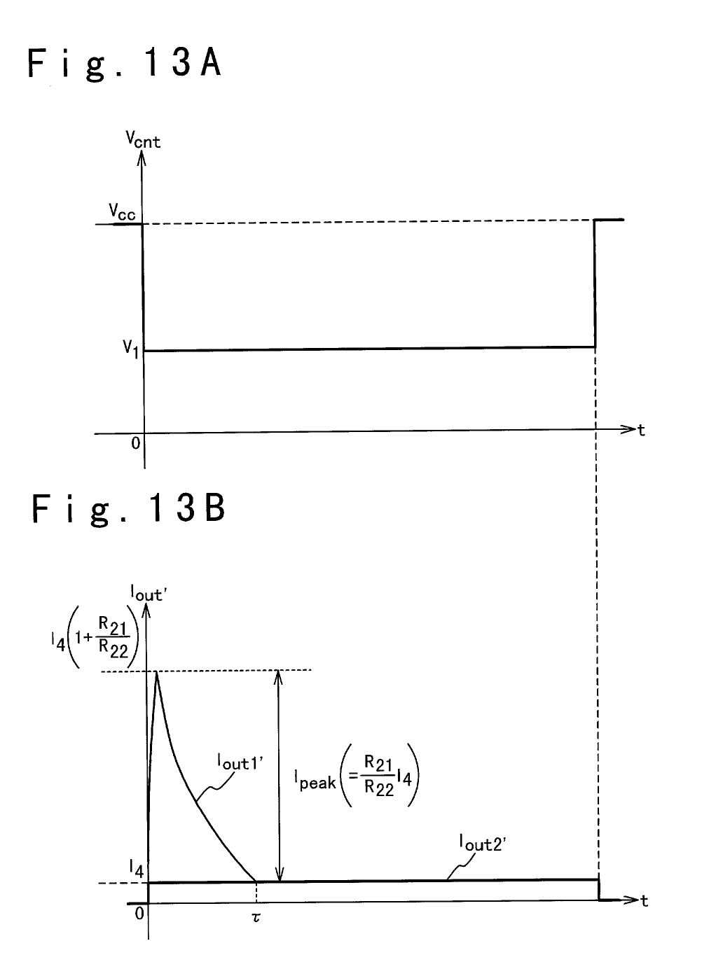

As shown in FIG. 13A, at an initial state, the control voltage V_{cnt} is set at the same voltage as a power supply potential V_{cc}.

When the drive current Iₒᵤₜ is outputted to the organic EL pixel 2, the control voltage V_{cnt} is set at a voltage V₁ lower than the power supply potential V_{cc}. At a time t=0, when the control voltage V_{cnt} is set at the voltage V₁, the currents are represented by:

$${I}_{4} = ( {V}_{cc} - {V}_{BE} - {V}_{1} ) / {R}_{21} , \\ {I}_{5} = {I}_{peak} \cdot exp ( - t / τ ) . \\ \begin{matrix}{I}_{{out}^{′}} = d \cdot {I}_{6} \\ = d \cdot ( {I}_{4} + {I}_{5} )\end{matrix}$$

Here,

Iₚₑₐₖ=(V_{cc}−V_{BE}−V₁)/R₂₂,

τ=R₂₂ C₂₁,

where V_{BE} is a forward voltage of a base-emitter junction of the transistors Q21, R₂₁ and R₂₂ are the resistance of the resistors R21, R22, respectively, C₂₁ is the capacitance of the capacitor C21.

Here, Iₚₑₐₖ=(R₂₁/R₂₂)·4

Thus, I_{S}=(R₂₁/R₂₂)·I₄·exp(−t/τ)

FIG. 13B shows the waveform of the drive current Iₒᵤₜ′. Let us suppose that the drive current Iₒᵤₜ′ in a range of 0<t<T is a current Iₒᵤₜ₁′. The current Iₒᵤₜ₁′ is represented by

Iₒᵤₜ₁′=d·I_{4 {1}+(R₂₁/R₂₂) exp(−t/τ)}.

In the range of 0<t<τ, the current Iₒᵤₜ₁, is outputted to the organic EL pixel 2, and the parasitic capacitor included in the organic EL pixel 2 is charged at a high speed.

On the other hand, let us suppose that the drive current Iₒᵤₜ, in a range of t>τ is a current Iₒᵤₜ₂′. The current Iₒᵤₜ₂′ is represented by

$$\begin{matrix}{I}_{{out2}^{′}} \approx d \cdot {I}_{4} , \\ = d \cdot ( {V}_{cc} - {V}_{BE} - {V}_{1} ) / {R}_{21} .\end{matrix}$$

The current Iₒᵤₜ₂′ is determined such that the organic EL pixel 2 emits the light at a desirable intensity. The voltage V₁ is determined such that the current Iₒᵤₜ₂′ is outputted to the organic EL pixel 2 on the basis of d, V_{cc}, V_{BE} and R₂₁.

Here,

Iₒᵤₜ₁.=Iₒᵤₜ₂′·{1+(R₂₁/R₂₂) exp (−t/τ)}.

That is, the current Iₒᵤₜ₁′ is determined depending on the current Iₒᵤₜ₂′. The current Iₒᵤₜ′ is determined such that the greater the current Iₒᵤₜ₂′, the greater the current Iₒᵤₜ₁′. That is, it is designed such that as the organic EL pixel 2 emits the light at a higher intensity, the current Iₒᵤₜ₁, becomes greater. Thus, the EL display in the second embodiment can increase the contrast of the EL display, similarly to the first embodiment. Moreover, in the EL display in the second embodiment, it is possible to reduce the influence from the ambient temperature.

As mentioned above, the present invention provides a technique for increase the contrast of the EL display according to the present invention.

Also, the present invention provides an EL display having the shorter time necessary for the light emission and also having the high contrast.

Also, the present invention provides an EL display that is not easily susceptible to the influence from the ambient temperature.

Moreover, the present invention provides an EL display that has the shorter time necessary for the light mission and is not easily susceptible to the influence from the ambient temperature.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. An electroluminescence display comprising:
an electroluminescence pixel; and
a driving circuit which drives said electroluminescence pixel to emit light, wherein said driving circuit provides a first drive current, and then provides a second drive current for said electroluminescence pixel, and said first drive current is larger than said second drive current, and increases depending on said second drive current.

2. The electroluminescence display according to claim 1, wherein said second drive current is determined based on a brightness of said light.

3. The electroluminescence display according to claim 1, wherein said first drive current is smaller than a limit current for maintaining a current-brightness property of said electroluminescence pixel substantially linear.

4. The electroluminescence display according to claim 1, wherein said first drive current is k times as large as said second drive current, where k is a constant larger than 1.

5. The electroluminescence display according to claim 4, wherein said k is defined such that
k≦Iₘₐₓ/Iₒᵤₜ₂₋ₘₐₓ,
where Iₘₐₓ is a limit current for maintaining a current-brightness property of said electroluminescence pixel substantially linear, and Iₒᵤₜ₂₋ₘₐₓ is a maximum value of said second drive current.

6. The electroluminescence display according to claim 4, wherein said k is determined based on a color of light emitted by said electroluminescence pixel.

7. The electroluminescence display according to claim 1, wherein said driving circuit includes:
a first current source unit generating a first current,
a second current source unit generating a second current, and
a current output unit superposing said first and second current to generate said first drive current.

8. The electroluminescence display according to claim 7, wherein said current output unit generates said second drive current from said first current.

9. A method of operating a electroluminescence display comprising:
providing a first drive current with a electroluminescence pixel; and
providing a second drive current with said electroluminescence pixel after said providing said first drive current, wherein said first drive current is larger than said second drive current, and increases depending on said second drive current.

10. The method according to claim 9, wherein said second drive current is determined based on a brightness of light emitted by said electroluminescence pixel.

11. The method according to claim 9, wherein said providing said first drive current includes:
generating a first current,
generating a second current, and
superposing said first and second current to provide said first drive current, and
said providing said second drive current includes outputting said first current to provide said second drive current.

12. The method according to claim 9 wherein said first drive current is smaller than a limit current for maintaining a current-brightness property of said electroluminescence pixel substantially linear.
